(19) United States
(12) Patent Application Publication
(10) Pub. No.: US 2022/0306947 A1
(43) Pub. Date: Sep. 29, 2022

(54) RING-OPENING PROCESSES AND CATALYSTS FOR HYDROCARBON SPECIES COMPRISING AROMATIC AND CYCLOPARAFFINIC RINGS

(71) Applicant: Chevron U.S.A. Inc., San Ramon, CA (US)

(72) Inventors: Michael Girgis, Richmond, CA (US); Stacey Ian Zones, San Francisco, CA (US)

(21) Appl. No.: 17/686,684

(22) Filed: Mar. 4, 2022

Related U.S. Application Data
(60) Provisional application No. 63/167,293, filed on Mar. 29, 2021.

(51) Int. Cl. C10G 47/20; C10G 53/06

(52) U.S. Cl. CPC C10G 47/20; C10G 53/06; C10G 2400/30; C10G 2300/70; C10G 2300/1096

(57) ABSTRACT

Embodiments of the disclosure include processes for ring-opening of hydrocarbon species comprising aromatic and cycloparaffinic rings in hydrocarbon feeds to produce ring-opened products. In particular, the process comprises contacting hydrocarbon species comprising aromatic and cycloparaffinic rings with hydrogen in the presence of a ring-opening catalyst comprising a noble metal on a low-acidity crystalline material containing external pockets to facilitate ring-opening of the hydrocarbon species comprising aromatic and cycloparaffinic rings. The processes are useful in the transformation of polynuclear aromatic hydrocarbons (PAHs) to ring-opened products.

### CROSS REFERENCE TO RELATED APPLICATIONS

The present application claims priority to U.S. Provisional Patent Application No. 63/167,293 filed Mar. 29, 2021, the entire contents of which are incorporated herein by reference.

### TECHNICAL FIELD

The present disclosure relates to processes for converting hydrocarbon species comprising aromatic and cycloparaffinic rings in hydrocarbon feeds with metal catalysts on low-acidity, crystalline materials.

### BACKGROUND

Hydrocracking processes are routinely used in refining to transform mixtures of hydrocarbons into products which can be upgraded easily. In order to increase the conversion of hydrocracking units, a portion of the unconverted feed is recycled, either to the reaction section through which it has already passed, or to an independent reaction section. Polynuclear aromatic hydrocarbons (PAHs) formed during cracking reactions accumulate in recycle streams of hydrocracking units. These species cause plugging of equipment and poison hydroprocessing catalysts.

PAHs comprise several condensed benzene nuclei or rings. Heavy polynuclear aromatic hydrocarbons, which include at least 3 benzene rings in each molecule, can be more difficult to hydrogenate and more likely to poison the catalysts. PAHs are solid materials with low volatility and low degradation rate. As such, PAHs tend to prevail over extended periods of time, for example in creosote and asphalt. Hundreds of types of PAH compounds have been identified in these materials.

Under certain hydrogenation conditions, PAHs can be treated to form partially hydrogenated hydrocarbon species which contain aromatic and cycloparaffinic rings.

In hydrocracking processes, it is desirable to open the rings of cycloparaffins to produce n-paraffins and branched paraffins. In particular, cycloparaffin-ring opening is an important reaction for upgrading petroleum streams to lubricant base stocks.

There remains a need for a process for converting PAHs and PAH precursors (e.g. partially hydrogenated polynuclear hydrocarbons) to lighter species, thereby reducing processing problems and facilitating the conversion of PAHs to valuable products.

In view of the foregoing, there is an ongoing need to provide cycloparaffin ring-opening catalysts and processes for improving hydroconversion of cycloparaffins in hydrocarbon feeds.

### SUMMARY

This summary is provided to introduce various concepts in a simplified form that are further described below in the detailed description. This summary is not intended to identify required or essential features of the claimed subject matter nor is the summary intended to limit the scope of the claimed subject matter.

Aspects of this disclosure are directed to processes for selective ring-opening of aromatic and cycloparaffinic rings in hydrocarbon feeds to produce ring-opened products. Advantageously, the processes can be used to selectively produce ring-opening of cycloparaffin rings and can be used to convert polynuclear aromatic hydrocarbons (PAHs) to lighter species.

In one aspect, a process for selective ring-opening of aromatic and cycloparaffinic rings comprises: contacting hydrocarbon species comprising aromatic and cycloparaffinic rings with hydrogen in the presence of a ring-opening catalyst comprising a noble metal on a low-acidity crystalline material containing external pockets to facilitate ring-opening of the hydrocarbon species comprising aromatic and cycloparaffinic rings.

In another aspect, a process for converting polynuclear aromatic hydrocarbons (PAHs) to ring-opened products comprises: (i) hydrogenation of PAHs by a hydrogenation catalyst and hydrogen to produce hydrocarbon species comprising aromatic and cycloparaffinic rings (i.e., partially hydrogenated species comprising aromatic and cycloparaffinic rings); and (ii) contacting the hydrocarbon species comprising aromatic and cycloparaffinic rings with hydrogen in the presence of a ring-opening catalyst comprising a noble metal on a low-acidity crystalline material containing external pockets to facilitate ring-opening of the hydrocarbon species comprising aromatic and cycloparaffinic rings.

In another aspect, hydrogen and a ring-opening catalyst comprising a noble metal on a low-acidity crystalline material containing external pockets are used to facilitate ring-opening of hydrocarbon species comprising aromatic and cycloparaffinic rings in accordance with a process described herein.

In another aspect, a composition comprises a ring-opened hydrocarbon species produced from hydrocarbon species comprising aromatic and cycloparaffinic rings treated in accordance with a process described herein.

This summary and the following detailed description provide examples and are explanatory only of the disclosure. Accordingly, the foregoing summary and the following detailed description should not be considered to be restrictive. Additional features or variations thereof can be provided in addition to those set forth herein, such as for example, various feature combinations and sub-combinations of those described in the detailed description.

### DEFINITIONS

To define more clearly the terms used herein, the following definitions are provided. Unless otherwise indicated, the following definitions are applicable to this disclosure. If a term is used in this disclosure but is not specifically defined herein, the definition from the IUPAC Compendium of Chemical Terminology can be applied, as long as that definition does not conflict with any other disclosure or definition applied herein or render indefinite or non-enabled any claim to which that definition is applied. To the extent that any definition or usage provided by any document incorporated herein by reference conflicts with the definition or usage provided herein, the definition or usage provided herein controls.

While compositions and methods are described in terms of “comprising” various components or steps, the compositions and methods can also “consist essentially of” or “consist of” the various components or steps, unless stated otherwise.

The terms “a,” “an,” and “the” are intended to include plural alternatives, e.g., at least one. The terms “including”, “with”, and “having”, as used herein, are defined as comprising (i.e., open language), unless specified otherwise.

Various numerical ranges are disclosed herein. When Applicant discloses or claims a range of any type, Applicant's intent is to disclose or claim individually each possible number that such a range could reasonably encompass, including end points of the range as well as any sub-ranges and combinations of sub-ranges encompassed therein, unless otherwise specified. For example, all numerical end points of ranges disclosed herein are approximate, unless excluded by proviso.

Values or ranges may be expressed herein as “about”, from “about” one particular value, and/or to “about” another particular value. When such values or ranges are expressed, other embodiments disclosed include the specific value recited, from the one particular value, and/or to the other particular value. Similarly, when values are expressed as approximations, by use of the antecedent “about,” it will be understood that the particular value forms another embodiment. It will be further understood that there are a number of values disclosed therein, and that each value is also herein disclosed as “about” that particular value in addition to the value itself. In another aspect, use of the term “about” means±20% of the stated value, ±15% of the stated value, ±10% of the stated value, ±5% of the stated value, ±3% of the stated value, or ±1% of the stated value.

“Periodic Table” refers to the version of IUPAC Periodic Table of the Elements dated Jun. 22, 2007, and the numbering scheme for the Periodic Table Groups is as described in Chemical and Engineering News, 63(5), 27 (1985).

“Hydrocarbonaceous” and “hydrocarbon” refer to a compound containing only carbon and hydrogen atoms. Other identifiers may be used to indicate the presence of particular groups, if any, in the hydrocarbon (e.g., halogenated hydrocarbon indicates the presence of one or more halogen atoms replacing an equivalent number of hydrogen atoms in the hydrocarbon).

“Hydroprocessing” or “hydroconversion” refers to a process in which a carbonaceous feedstock is brought into contact with hydrogen and a catalyst, at a higher temperature and pressure, for the purpose of removing undesirable impurities and/or converting the feedstock to a desired product. Such processes include, but are not limited to, methanation, water gas shift reactions, hydrogenation, hydrotreating, hydrodesulphurization, hydrodenitrogenation, hydrodemetallation, hydrodearomatization, hydroisomerization, hydrodewaxing and hydrocracking including selective hydrocracking. Depending on the type of hydroprocessing and the reaction conditions, the products of hydroprocessing can show improved physical properties such as improved viscosities, viscosity indices, saturates content, low temperature properties, volatilities and depolarization.

“Hydrocracking” refers to a process in which hydrogenation and dehydrogenation accompanies the cracking/fragmentation of hydrocarbons, e.g., converting heavier hydrocarbons into lighter hydrocarbons, or converting aromatics and cycloparaffins into non-cyclic paraffins.

“Cycloparaffin” refers to a compound having the general formula CₙH₂ₙ and is characterized by having one or more rings of saturated carbon atoms. In cycloparaffins with multiple rings, the rings can be fused. Cycloparaffins can include substituents and aromatic rings, but must also contain one or more rings of saturated carbon atoms.

The terms “binder” or “support”, particularly as used in the term “catalyst support”, refer to conventional materials that are typically a solid with a high surface area, to which catalyst materials are affixed. Support materials may be inert or participate in the catalytic reactions, and may be porous or non-porous. Typical catalyst supports include various kinds of carbon, alumina, silica, and silica-alumina, e.g., amorphous silica aluminates, zeolites, alumina-boria, silica-alumina-magnesia, silica-alumina-titania and materials obtained by adding other zeolites and other complex oxides thereto.

“Molecular sieve” refers to a crystalline microporous solid having uniform pores of molecular dimensions within a framework structure, such that only certain molecules, depending on the type of molecular sieve, have access to the pore structure of the molecular sieve, while other molecules are excluded, e.g., due to molecular size and/or reactivity. Zeolites, crystalline aluminophosphates and crystalline silicoaluminophosphates are representative examples of molecular sieves.

The terms “catalyst particles”, “catalyst composition,” “catalyst mixture,” “catalyst system,” and the like, encompass the initial starting components of the composition, as well as whatever product(s) may result from contacting these initial starting components, and this is inclusive of both heterogeneous and homogenous catalyst systems or compositions.

Applicant reserves the right to proviso out or exclude any individual members of any such group of values or ranges, including any sub-ranges or combinations of sub-ranges within the group, that can be claimed according to a range or in any similar manner, if for any reason Applicant chooses to claim less than the full measure of the disclosure, for example, to account for a reference that Applicant may be unaware of at the time of the filing of the application. Further, Applicant reserves the right to proviso out or exclude any members of a claimed group.

Although any processes and materials similar or equivalent to those described herein can be used in the practice or testing of the invention, the typical processes and materials are herein described.

All publications and patents mentioned herein are incorporated herein by reference for the purpose of describing and disclosing, for example, the constructs and methodologies that are described in the publications, which might be used in connection with the presently described invention. The publications discussed throughout the text are provided solely for their disclosure prior to the filing date of the present application. Nothing herein is to be construed as an admission that the inventors are not entitled to antedate such disclosure by virtue of prior invention.

### DETAILED DESCRIPTION

It is to be understood that the disclosure is not limited in its application to the details of construction and the arrangement of components set forth in the following description or illustrated in the drawings.

The present disclosure generally relates to processes for converting polynuclear aromatic hydrocarbons (PAHs) and PAH precursors (e.g. partially hydrogenated polynuclear hydrocarbons or hydrocarbon species comprising aromatic and cycloparaffinic rings) to ring-opened products, thereby reducing processing problems and faciliatating the conversion of PAHs to valuable products. In particular, the present disclosure relates to exemplary ring-opening catalysts, which facilitate ring-opening of hydrocarbon species comprising aromatic and cycloparaffinic rings present in any hydrocarbon feed, such as a hydrocracker recycle stream. The processes according to the embodiments comprise at least the step of contacting the hydrocarbon species comprising aromatic and cycloparaffinic rings with hydrogen in the presence of a ring-opening catalyst comprising a noble metal on a low-acidity crystalline material containing external pockets to facilitate ring-opening of the hydrocarbon species comprising aromatic and cycloparaffinic rings. Exemplary ring-opening catalysts include, for example, one or more noble metals on a low-acidity crystalline material formed from the delamination of a zeolite selected from a borosilicate or aluminoborosilicate molecular sieve containing at least 0.05 weight percent boron and less than 1000 ppm by weight of aluminum, or a titanosilicate molecular sieve; aluminosilicate; and silico-aluminium phosphates and mixtures thereof. In particular embodiments, the low-acidity crystalline material can be formed from the delamination of one or more types of zeolite selected from: SSZ-33, SSZ-46, SSZ-53, SSZ-55, SSZ-57, SSZ-58, SSZ-59, SSZ-60, SSZ-64, SSZ-70, ZSM-5, ZSM-11, TS-1, MTT (e.g., SSZ-32, ZSM-23 and the like), H—Y and combinations thereof.

In particular embodiments, the low-acidity crystalline material can be formed from the delamination of one or more types of zeolite selected from: SSZ-35, SSZ-54, SSZ-70, SSZ-74, SSZ-91, SSZ-95, SSZ-109, SSZ-31, SSZ-42, SSZ-43, SSZ-48, SSZ-55, SSZ-57, SSZ-63, SSZ-64, SSZ-65, SSZ-96, SSZ-106, Y, USY, Beta, ZSM-4, MFI (e.g., ZSM-5), ZSM-12, ZSM-18, ZSM-20, MTT (e.g., ZSM-23), FER (e.g., ZSM-35), *MRE (e.g., ZSM-48), L and combinations thereof.

Generally, the processes are applied to a hydrocarbon feed (for example, a hydrocracker recycle stream) which comprises aromatic and cycloparaffinic rings. In certain embodiments, the processes comprise the step of contacting the hydrocarbon species comprising aromatic and cycloparaffinic rings with hydrogen in the presence of a ring-opening catalyst comprising a noble metal on a low-acidity crystalline material containing external pockets to facilitate ring-opening of the hydrocarbon species comprising aromatic and cycloparaffinic rings.

In certain embodiments, the process comprises the steps of (i) hydrogenation of PAHs by a hydrogenation catalyst and hydrogen to to produce hydrocarbon species comprising aromatic and cycloparaffinic rings (i.e., partially hydrogenated species comprising aromatic and cycloparaffinic rings); (ii) contacting the hydrocarbon species comprising aromatic and cycloparaffinic rings with hydrogen in the presence of a ring-opening catalyst comprising a noble metal on a low-acidity crystalline material containing external pockets to facilitate ring-opening of the hydrocarbon species comprising aromatic and cycloparaffinic rings.

Hydrogenation of PAHs

A polynuclear (or polycyclic) aromatic hydrocarbon (PAH) is a hydrocarbon comprising two or more aromatic rings, for example C₁₀ to C₃₂ PAHs. PAHs are uncharged, non-polar molecules, with distinctive properties due in part to the delocalized electrons in their aromatic rings. Heavier PAHs comprise at least 4, or at least 6, benzene rings in each molecule.

Polynuclear aromatic hydrocarbons are primarily found in natural sources such as bitumen. PAHs can also be produced geologically when organic sediments are chemically transformed into fossil fuels such as oil and coal. The rare minerals idrialite, curtisite, and carpathite consist almost entirely of PAHs that originated from such sediments. Examples of PAHs are shown in Table 1.

TABLE 1
Example polynuclear aromatic hydrocarbons

| Name | Structure |
|---|---|
| Naphthalene | 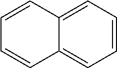 |
| Pyrene | 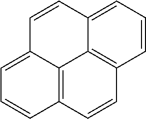 [SMILES: c1cc2ccc3cccc4ccc(c1)c2c34] |
| Biphenyl | 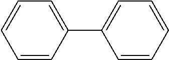 [SMILES: c1ccc(-c2ccccc2)cc1] |
| Pentacene | 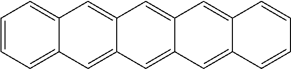 [SMILES: c1ccc2cc3cc4cc5ccccc5cc4cc3cc2c1] |
| Fluorene | 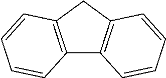 [SMILES: c1ccc2c(c1)Cc1ccccc1-2] |
| Perylene | 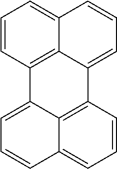 [SMILES: c1cc2cccc3c4cccc5cccc(c(c1)c23)c54] |
| Anthracene | 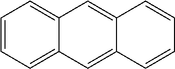 [SMILES: c1ccc2cc3ccccc3cc2c1] |
| Benzo[a]pyrene | 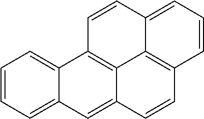 [SMILES: c1ccc2c(c1)cc1ccc3cccc4ccc2c1c34] |
| Phenanthrene | 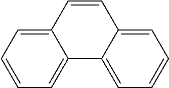 [SMILES: c1ccc2c(c1)ccc1ccccc12] |
| Corannulene | 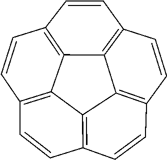 [SMILES: c1cc2ccc3ccc4ccc5ccc1c1c2c3c4c51] |
| Phenalene | 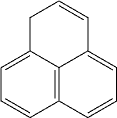 [SMILES: C1=Cc2cccc3cccc(c23)C1] |
| Benzo[ghi]perylene | 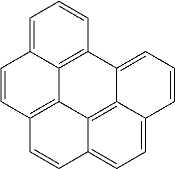 [SMILES: c1cc2ccc3ccc4ccc5cccc6c(c1)c2c3c4c56] |
| Tetracene | 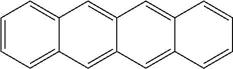 [SMILES: c1ccc2cc3cc4ccccc4cc3cc2c1] |
| Coronene | 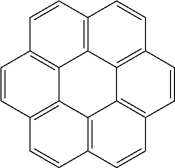 [SMILES: c1cc2ccc3ccc4ccc5ccc6ccc1c1c2c3c4c5c61] |
| Chrysene | 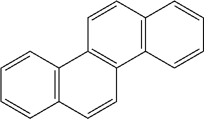 [SMILES: c1ccc2c(c1)ccc1c3ccccc3ccc21] |
| Ovalene | 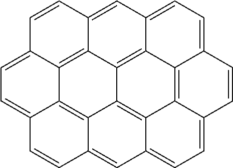 [SMILES: c1cc2ccc3cc4ccc5ccc6ccc7cc8ccc1c1c2c3c2c4c5c6c7c2c81] |
| Triphenylene | 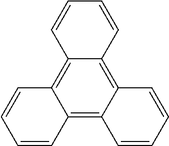 [SMILES: c1ccc2c(c1)c1ccccc1c1ccccc21] |
| Benzo[c]fluorene | 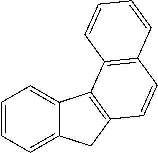 [SMILES: c1ccc2c(c1)Cc1ccc3ccccc3c1-2] |

In processes according to the embodiments, the hydrogenation of PAHs occurs by contacting the PAHs, or a hydrocarbon feed comprising PAHs, with a hydrogenation catalyst and hydrogen to produce partially hydrogenated species comprising aromatic and cycloparaffinic rings (i.e., hydrocarbon species comprising aromatic and cycloparaffinic rings). A wide variety of feeds may be treated in the hydrogenation step. The boiling point of the compounds in the feed are not particularly limited. In certain embodiments, the feed comprises at least 10% by volume, at least 20% by volume, or least 80% by volume of compounds boiling above 340° C.

Generally, the feed may be any feed in which the major component consists of hydrocarbons and the feed has a low nitrogen and low sulfur content. In certain embodiments, the feed has about 50 ppm or less nitrogen. In certain embodiments, the feed has about 50 ppm or less sulfur. The feed may, for example, be hydrocracker recycle streams, light gas oils obtained from a catalytic cracking unit), as well as feeds originating from units for the extraction of aromatics from lubricating oil bases or obtained from solvent dewaxing of lubricating base oils, or the feed may in fact be a deasphalted oil, effluents from a Fischer-Tropsch unit or in fact any mixture of the feeds cited above. The above list is not limiting.

In general, the feeds have a T5 boiling point of more than 150° C. (i.e. 95% of the compounds present in the feed have a boiling point of more than 150° C.). In the case of gas oil, the T5 point is generally approximately 150° C. In the case of VGO, the T5 is generally more than 340° C., or even more than 370° C. The feeds which may be used thus fall within a wide range of boiling points. This range generally extends from gas oil to VGO, encompassing all possible mixtures with other feeds, for example LCO.

The hydrogenation catalyst and conditions for the hydrogenation step can be any suitable hydrogenation catalyst and conditions known in the art. In certain embodiments, the hydrogenation catalyst is a highly active hydrogenation catalyst comprising a metal selected from the group consisting of platinum, palladium, nickel, ruthenium, rhodium, osmium, iridium, and gold, for example platinum, on a support such as alumina or silica.

In the hydrogenation step, two or more hydrogens are added to the PAH structure, HnPAH is formed, wherein n is an even integer of 2 or more. Generally, the PAH compound is not completely hydrogenated, but the HnPAH compounds may include partially or completely hydrogenated compounds. The HnPAH products include hydrocarbon species comprising aromatic and cycloparaffinic rings. An example of phenanthrene and hydrogenation products thereof is shown in Scheme 1 below.

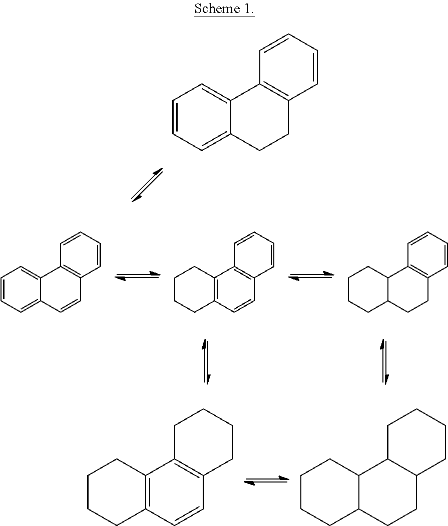

Cycloparaffinic rings are residues of cycloparaffins, which are compounds having the general formula CₙH₂ₙ and one or more rings of saturated carbon atoms. In cycloparaffins with multiple rings, the rings can be fused. Cycloparaffins can include substituents and aromatic rings, but must also contain one or more rings of saturated carbon atoms.

Catalyzed Ring-Opening of Hydrocarbon Species Comprising Aromatic and Cycloparaffinic Rings

In processes according to the embodiments, the catalyzed ring-opening of the PAHs-hydrogenation products or the hydrocarbon species comprising aromatic and cycloparaffinic rings occurs by contacting the hydrocarbon species comprising aromatic and cycloparaffinic rings with hydrogen in the presence of a ring-opening catalyst comprising a noble metal on a low-acidity crystalline material containing external pockets to facilitate ring-opening of the hydrocarbon species comprising aromatic and cycloparaffinic rings.

In certain embodiments, the process comprises cycloparaffinic ring-opening by contacting a cycloparaffin with hydrogen in the presence of a ring-opening catalyst comprising a noble metal on a low-acidity crystalline material. In general, the ring-opening catalyst comprises a noble metal-containing, low-acidity, crystalline material with external pockets which facilitates ring-opening (i.e., carbon-carbon bond breaking) between unsubstituted carbon atoms in a cycloalkyl portion in the cycloparaffinic rings of the PAHs-hydrogenation products or the hydrocarbon species comprising aromatic and cycloparaffinic rings.

In certain embodiments, the processes disclosed herein may be used for reacting a feed comprising hydrocarbon species comprising aromatic and cycloparaffinic rings at conditions of elevated temperatures and pressures in the presence of hydrogen and ring-opening catalyst particles to open the cycloparaffinic rings in the feed, i.e. to convert the cycloparaffinic rings to branched paraffin moieties.

Cycloparaffin ring-opening is an important reaction for upgrading petroleum streams. Superior cold flow properties (i.e., low pour point) can be achieved by converting cycloparaffins to branched paraffins. Aromatic ring saturation may also occur during the processes described herein. In certain embodiments, the processes can be used to upgrade components containing aromatic rings to branched paraffins or branched cycloparaffins, thereby improving viscosity index cold flow properties.

Exemplary ring-opening catalysts include, for example, one or more metals on a low-acidity crystalline material formed from the delamination of a zeolite selected from a borosilicate or aluminoborosilicate molecular sieve containing at least 0.05 weight percent boron and less than 1000 ppm by weight of aluminum, or a titanosilicate molecular sieve; aluminosilicate; and silico-aluminium phosphates and mixtures thereof. In particular embodiments, the low-acidity crystalline material can be formed from the delamination of one or more types of zeolite selected from: SSZ-33, SSZ-46, SSZ-53, SSZ-55, SSZ-57, SSZ-58, SSZ-59, SSZ-60, SSZ-64, SSZ-70, ZSM-5, ZSM-11, TS-1, MTT (e.g., SSZ-32, ZSM-23 and the like), H—Y and combinations thereof.

In particular embodiments, the low-acidity crystalline material can be formed from the delamination of one or more types of zeolite selected from: SSZ-35, SSZ-54, SSZ-70, SSZ-74, SSZ-91, SSZ-95, SSZ-109, SSZ-31, SSZ-42, SSZ-43, SSZ-48, SSZ-55, SSZ-57, SSZ-63, SSZ-64, SSZ-65, SSZ-96, SSZ-106, Y, USY, Beta, ZSM-4, MFI (e.g., ZSM-5), ZSM-12, ZSM-18, ZSM-20, MTT (e.g., ZSM-23), FER (e.g., ZSM-35), *MRE (e.g., ZSM-48), L and combinations thereof.

In certain embodiments, the ring-opening catalyst comprises a noble metal selected from the group consisting of platinum, palladium, nickel, rhodium, iridium, ruthernium, osmium and mixtures thereof. In certain embodiments, the noble metal is selected from the group consisting of platinum, nickel, rhodium and mixtures thereof. In certain embodiments, the noble metal comprises platinum.

The metal may be incorporated into the catalyst composition by any suitable method known in the art, such as impregnation or exchange onto the zeolite. The metal may be incorporated in the form of a cationic, anionic or neutral complex. For example, [Pt(NH₃)_{4]}²+ and cationic complexes of this type will be found convenient for exchanging platinum onto the zeolite. In certain embodiments, the amount of metal on the zeolite is about 0.003 to about 10 percent by weight, about 0.01 to about 10 percent by weight, about 0.1 to about 2.0 percent by weight, or about 0.1 to about 1.0 percent by weight. In certain embodiments, the amount of platinum on the zeolite is about 0.01 to about 10 percent by weight, about 0.1 to about 2.0 percent by weight, or about 0.1 to about 1.0 percent by weight. In certain embodiments, the source of platinum in the catalyst synthesis is platinum tetraamine dinitrate. In certain embodiments, the metal is introduced into the catalyst composition with a pH neutral or basic solution. In certain embodiments, the platinum is introduced into the catalyst composition with a pH neutral or basic solution.

A high level of metal dispersion in the catalyst or catalyst composition is generally preferred. For example, platinum dispersion is measured by the hydrogen chemisorption technique and is expressed in terms of H/Pt ratio. The higher the H/Pt ratio, the higher the platinum dispersion. In certain embodiments, the zeolite should have an H/Pt ratio greater than about 0.8.

One or more binder materials may also be used with the zeolite. Generally desirable properties for the binder material are good mixing/extrusion characteristics, good mechanical strength after calcination, and reasonable surface area and porosity to avoid possible diffusion problems during catalyst use. Examples of suitable binder materials include, but are not limited to: silica-containing binder materials, such as silica, silica alumina, silica-boria, silica-magnesia, silica-zirconia, silica-thoria, silica-berylia, silica-titania, silica-alumina-boria, silica alumina-thoria, silica-alumina-zirconia, silica-alumina magnesia or silica-magnesia-zirconia; inorganic oxides; aluminum phosphate; and combinations thereof. In certain embodiments, the binder material does not comprise zeolitic materials.

When used, the ratio of binder to zeolite will typically vary from about 9:1 to about 1:9, more commonly from about 3:1 to about 1:3 (by weight).

Generally, the zeolite useful in the catalyst compositions and processes described herein is an aluminosilicate with low-acidity, including low alumina content and a high silica-to-alumina mole ratio. In one embodiment, the zeolite is an aluminosilicate. In certain embodiments, the zeolite is an aluminosilicate having a low alumina content and a high silica-to-alumina mole ratio.

Typically, the process is conducted under suitable hydrocracking conditions for the particular catalyst used. In certain embodiments, the process is conducted at a temperature of about 200° C. to about 400° C. In certain embodiments, the process is conducted at a pressure in the range of about 1 psig to about 2500 psig. In certain embodiments, the process is conducted at a weight hourly space velocity in the range of about 0.4 to about 2.0 WHSV hr⁻¹.

The amount of hydrogen present in the process can be in the range of about 2 to about 10 for the H₂/cycloparaffin mole ratio. Typically, the amount of hydrogen present in the process is in the range of about 3 to about 5 for the H₂/cycloparaffin mole ratio.

In one embodiment, a hydrotreating step using a conventional hydrotreating catalyst may also be carried out to remove nitrogen and sulfur and to saturate aromatics to naphthenes without substantial boiling range conversion. Suitable hydrotreating catalysts generally comprise a metal hydrogenation component, usually a Group 6 or Group 8-10 metal. Hydrotreating will usually improve catalyst performance and permit lower temperatures, higher space velocities, lower pressures or combinations of these conditions to be employed.

The process of the present disclosure provides a number of advantages, as supported by the examples that follow, including facilitating ring-opening of cycloparaffins between unsubstituted carbons with high conversion rates and high selectivity. In certain embodiments, the process results in greater than about 90% conversion of the cycloparaffins in the hydrocarbon feed. In certain embodiments, the process results in selectivity for ring-opening products of greater than about 60% or about 65% of the cycloparaffins in the hydrocarbon feed. Advantageously, processes according to the embodiments can be used to facilitate cycloparaffin ring-opening without excessive formation of less-valuable light products (e.g., gases such as methane, ethane and propane).

Methods of Preparing the Low-acidity Crystalline Materials and Catalysts

The ring-opening catalysts according to the embodiments include one or more noble metals on a low-acidity crystalline material formed from the delamination of suitable zeolites. The low-acidity crystalline material comprises external pockets which are formed by the delamination of the zeolites. Suitable zeolites contain large cavities which, upon delamination, become large exterior pockets. These pockets are advantageous in the adsorption of polynuclear aromatic hydrocarbons. The low-acidity crystalline materials also have high external surface areas, allowing for a large concentration of catalytic sites and thus allowing reactions to proceed at rates that are well-suited for industrial applications.

Zeolite catalysts are widely used in petroleum refining and fine chemical synthesis. The well-defined active sites of zeolites, which consist of heteroatoms substituted within framework positions, impact the utility and shape selectivity of these materials in catalytic reactions. Many small molecule substrates readily fit inside the micropore of zeolites, where most active sites are located. In the interest of expanding the scope of substrates to include larger molecules, zeolite-based materials such as extra-large-pore zeolites, delaminated layered zeolite precursor materials, single-unit-cell zeolite nanosheets, hierarchically nanoporous zeolite-like materials, and self-pillared zeolite nanosheets have been developed. These materials facilitate catalytic reactions with sterically bulky substrates (or reactants), which would be unable to access active sites within internal micropores.

Ouyang et al. report a delaminated borosilicate zeolite precursor material displays a 2.3-fold enhancement in its initial rate of catalysis relative to the 3D-calcined material, which is nearly equal to its 2.5-fold measured increase in external surface area (see X. Ouyang et al., J. Am. Chem. Soc. 2014, 136, 1449-1461.) A layered borosilicate zeolite precursor ERB-1P (SUB=11) was delaminated via isomorphous substitution of aluminum for boron using aqueous aluminum nitrate treatment to produce the delaminated zeolite catalyst.

U.S. Pat. No. 9,795,951 describes certain surfactant-free, single-step syntheses of delaminated aluminosilicate zeolites.

In certain embodiments, the low-acidity crystalline material can be formed from the delamination of one or more types of zeolite described herein. Delamination refers to the peeling apart of layers in a zeolite. Through the delamination process, the low-acidity crystalline material according to the embodiments is formed. Delamination is often accompanied by an increase in the external surface area of the material, sometimes by as much as 10 fold. Preferably, the delamination step facilitates an increase in surface area that is largely due to the increase in external surface area exposed rather than contributions from other phases such as amorphous phases.

The low-acidity crystalline materials may comprise delaminated metallosilicate zeolites, such as those described in U.S. Pat. No. 9,795,951, the entirety of which is incorporated herein by reference. For example, the low-acidity crystalline materials may be prepared by a process comprising exfoliating zeolites (e.g., borosilicate zeolite) via disruption of hydrogen bonds between layers by treating with warm metal salt solutions. In such delamination (exfoliation) processes, the metal salt solution can be either a dissolved metal salt in a solvent or the neat metal salt, in the case of metal salts that are themselves intrinsically liquids under conditions of contacting. The metal salt refers to any coordination of a metal cation with an anion including inorganic anions such as nitrate and chloride as well as organic anions such as acetate and citrate and organic ligands such as alkoxide, carboxylates, halides and alkyls.

In certain embodiments, the exfoliation of the zeolites comprises treatment of the zeolites in warm ARNO), aqueous solution. During this treatment, interlayer hydrogen bonding in the zeolite is disrupted (and persists even after calcination at 550° C.) via lattice distortion, which is induced by substitution of B for Al.

In certain embodiments, the exfoliation of the zeolites comprises treatment of the zeolites in warm Zn(NO₃)₂ aqueous solution at pH of about 1. The interlayer hydrogen bonding in the zeolite is disrupted, and accompanied by the formation of silanol nests induced by B removal from the framework. Within this context, silanol nests refers to a plurality of silanols arranged within a template that used to be occupied by B. The high surface area and silanol nests of the exfoliated zeolites persist even after calcination at 550° C.

In certain embodiments, after delamination, the crystalline material may be partially demetallated, for example, to afford a more active catalyst. Partial demetallation refers to removal of a portion of the heteroatoms within the catalyst, typically the portion that is bonded more weakly and, typically, this is the portion that is not as fully condensed to the zeolite framework. When applied to Al metal, the process of demetallation is termed dealumination. There are several preferred methods of dealumination, and this specification is not to be limited in any way based on the method of demetallation practiced. For example, it is well known in the art that dealumination can accomplished by either (i) a brief aqueous acid solution treatment (Barrer, R. M., Makki, M. B. (1964) Can J Chem 42:1481); (ii) steam treatment (Scherzer, J. The Preparation and Characterization of Aluminum Deficient Zeolite, “Catalytic Materials” ACS Symposium Series. 1984, 248:157-200); and (iii) ammonium fluorosilicate treatment (Breck, D. W., Blass, H., Skeels, G. W. (1985) U.S. Pat. No. 4,503,023, Union Carbide Corp).

In certain embodiments, the low-acidity crystalline material is a delaminated aluminosilicate zeolite. In certain embodiments, the low-acidity crystalline material is formed from the delamination of one or more types of aluminosilicate zeolite. Once recovered from metal salt solution, the delaminated aluminosilicate zeolite can be calcined.

In certain embodiments, the low-acidity crystalline materials comprise disordered stacking of thin sheets along the c-axis. Generally, the low-acidity crystalline materials possess a high density of strong acid sites on the external surface.

In certain embodiments, the low-acidity crystalline materials comprise a delaminated silanol-nest-containing zeolite.

The low-acidity crystalline materials may comprise delaminated zeolites, such as those described in U.S. Patent Publication No. 2012/0148487, the entirety of which is incorporated herein by reference. For example, the low-acidity crystalline materials may be prepared by a process comprising exfoliating zeolites comprising preparing a non-aqueous mixture of chloride and fluoride anions comprising an organic solvent and a zeolite to be delaminated, maintaining the mixture at a temperature in the range of about 50 to about 150° C. for a length of time sufficient to effect the desired delamination, then recovering the low-acidity crystalline materials. The organic solvent can be any suitable organic solvent, such as dimethyl formamide. Generally, acidification is used to recover the product.

In certain embodiments, the low-acidity crystalline material can be formed from the delamination of one or more types of zeolite selected from MCM-22 (P), SSZ-25, ERB-1, PREFER, SSZ-70 (e.g., Al-SSZ-70, or B-SSZ-70) and Nu-6(1). The chloride and fluoride anions can be obtained from any source of the anions. The molar ratio of chloride to fluoride anions can be in the range of about 100:1 to 1:100. Any compound which will provide the anions in aqueous solution can be used. Any suitable cation can be used in the delamination process. In certain embodiments, the cation comprises an alkylammonium cation, wherein the alkyl group is a C₁ to C₂₀ alkyl group.

In one aspect, the present disclosure provides for using hydrogen and a ring-opening catalyst comprising a noble metal on a low-acidity crystalline material containing external pockets to facilitate ring-opening of hydrocarbon species comprising aromatic and cycloparaffinic rings in a process according to the embodiments described herein.

In another aspect, the present disclosure provides for a composition comprising a ring-opened hydrocarbon species produced from hydrocarbon species comprising aromatic and cycloparaffinic rings treated in a process according to the embodiments described herein.

### EXAMPLES

The disclosed embodiments are further illustrated by the following examples, which are not to be construed in any way as imposing limitations to the scope of this disclosure. Various other aspects, embodiments, modifications, and equivalents thereof may be apparent to one of ordinary skill in the art, after reading the description herein, without departing from the scope of the present disclosure or the scope of the amended claims.

### Example 1

An alumina carrier material comprising 1/16 inch spheres is prepared by: forming an aluminum hydroxyl chloride sol by dissolving substantially pure aluminum pellets in a hydrochloric acid solution, adding hexamethylenetetramine to the resulting alumina sol, gelling the resulting solution by dropping it into an oil bath to form spherical particles of an alumina hydrogel, aging and washing the resulting particles and finally drying and calcining the aged and washed particles to form spherical particles of gamma-alumina containing about 0.3 wt % combined chloride.

Measured amounts of the desired noble metal compounds, for example choroplatinic acid, are dissolved in a suitable solvent, for example water, with a strong acid such as hydrogen chloride to form an impregnation solution. If more than one metal compound is used to form the catalyst, separate solutions of the metal compounds, in the same or different solvents, can be prepared and then combined. If necessary, the solutions may be aged, for example, at room temperature until an equilibrium condition is established therein prior to combining the metal solutions to form an impregnation solution.

The alumina carrier material is thereafter admixed with the impregnation solution. The amount of the metal contained in this impregnation solution can be in the range of about 0.3 to about 1.5 wt % on an elemental basis. In order to insure uniform dispersion of the metallic components throughout the carrier material, the amount of the hydrogen chloride used in this impregnation solution is about 3 wt % of the alumina particles. This impregnation step is performed by adding the carrier material particles to the impregnation mixture with constant agitation. In addition, the volume of the solution is approximately the same as the void volume of the carrier material particles so that all of the particles are immersed in the impregnation solution. The impregnation mixture is maintained in contact with the carrier material particles for a period of about ½ to about 3 hours at a temperature of about 70° F. Thereafter, the temperature of the impregnation mixture is raised to about 225° F. and the excess solution is evaporated in a period of about 1 hour. The resulting dried impregnated particles are then subjected to an oxidation treatment in a dry air stream at a temperature of about 975° F. and a GHSV of about 500 hr⁻¹ for about ½ hour. This oxidation step is designed to convert substantially all of the metallic ingredients to the corresponding oxide forms. The resulting oxidized spheres are subsequently contacted in a halogen treating step with an air stream containing H₂O and HCl in a mole ratio of about 30:1 for about 2 hours at 975° F. and a GHSV of about 500 hr⁻¹ in order to adjust the halogen content of the catalyst particles to a value of about 1.09 wt %. The halogen-treated spheres are thereafter subjected to a second oxidation step with a dry air stream at 975° F. and a GHSV of 500 hr⁻¹ for an additional period of about ½ hour. The oxidized and halogen-treated catalyst particles may then be subjected to a dry pre-reduction treatment, designed to reduce at least the platinum component to the elemental state, by contacting them for about 1 hour with a substantially hydrocarbon-free dry hydrogen stream containing less than 5 vol ppm H₂O at a temperature of about 1050° F., a pressure slightly above atmospheric, and a flow rate of the hydrogen stream through the catalyst particles corresponding to a GHSV of about 400 hr⁻¹.

A sample of the resulting reduced catalyst particles is analyzed and will be found to contain, on an elemental basis, about 0.30 to about 1.5 wt. % desired metal, and about 1.09 wt. % chloride.

### Example 2

In this example, the present invention, is illustrated as applied to the hydrogenation of aromatic hydrocarbons such as benzene, toluene, the various xylenes, naphthalenes, etc., to form the corresponding cyclic paraffins. The corresponding cyclic paraffins, resulting from the hydrogenation of the aromatic nuclei, include compounds such as cyclohexane, mono-, di-, tri-substituted cyclohexanes, decahydronaphthalene, tetrahydronaphthalene, etc., which find widespread use in a variety of commercial industries in the manufacture of nylon, as solvents for various fats, oils, waxes, etc.

Aromatic concentrates are obtained by a multiplicity of techniques. For example, a benzene-containing fraction may be subjected to distillation to provide a heart-cut which contains the benzene. This is then subjected to a solvent extraction process which separates the benzene from the normal or iso-paraffinic components, and the naphthenes contained therein. Benzene is readily recovered from the selected solvent by way of distillation, and in a purity of 99.0% or more. In accordance with the present process, the benzene is hydrogenated in contact with a low acidity catalytic composite containing 0.01 to about 12.0% by weight of a metal component, e.g. platinum component or a mixture of metals, and from about 0.01 to about 1.5% by weight of an alkalinous metal component. Operating conditions include a maximum catalyst bed temperature in the range of about 200° to about 800° F., a pressure of from 500 to about 2,500 psig, a liquid hourly space velocity of about 1.0 to about 10.0 and a hydrogen circulation rate in an amount sufficient to yield a mole ratio of hydrogen to cyclohexane, in the product effluent from the last reaction zone, not substantially less than about 4.0:1. Although not essential, one preferred operating technique involves the use of three reaction zones, each of which contains approximately one-third of the total quantity of catalyst employed. The process is further facilitated when the total fresh benzene is added in three approximately equal portions, one each to the inlet of each of the three reaction zones.

The catalyst utilized is an alumina carrier material combined with about 0.3 to about 1.5% by weight of metal, such as platinum, and about 0.90% by weight of lithium, all of which are calculated on the basis of the elemental metals. The hydrogenation process will be described in connection with a commercially-scaled unit having a total fresh benzene feed capacity of about 1,488 barrels per day. Make-up gas in an amount of about 741.6 mols/hr. together with hydrogen recovered from the reactor effluent is admixed with 2,396 Bbl/day (about 329 mols/hr) of a cyclohexane recycle stream, the mixture being at a temperature of about 137° F., and further mixed with 96.24 mols/hr (582 Bbl./day) of the benzene feed; the final mixture constitutes the total charge to the first reaction zone. Following suitable heat-exchange with various hot effluent streams, the total feed to the first reaction zone is at a temperature of 385° F. and a pressure of 460 psig. The reaction zone effluent is at a temperature of 606° F. and a pressure of about 450 psig. The total effluent from the first reaction zone is utilized as a heat-exchange medium, in a stream generator, whereby the temperature is reduced to a level of about 545° F. The cooled effluent is admixed with about 98.5 moles per hour (596 Bbl./day) of fresh benzene feed, at a temperature of 100° F.; the resulting temperature is 400° F., and the mixture enters the second reaction zone at a pressure of about 440 psig. The second reaction zone effluent, at a pressure of 425 psig. and a temperature of 611° F., is admixed with 51.21 mols/hr (310 Bbl./day) of fresh benzene feed, the resulting mixture being at a temperature of 5788° F. Following its use as a heat-exchange medium, the temperature is reduced to 400° F., and the mixture enters the third reaction zone at a pressure of 415 psig. The third reaction zone effluent is at a temperature of about 500° F. and a pressure of about 400 psig. Through utilization as a heat-exchange medium, the temperature is reduced to a level of about 244° F., and subsequently reduced to a level of about 115° F. by use of an air-cooled condenser. The cooled third reaction zone effluent is introduced into a high pressure separator, at a pressure of about 370 psig.

A hydrogen-rich vaporous phase is withdrawn from the high pressure separator and recycled by way of compressive means, at a pressure of about 475 psig, to the inlet of the first reaction zone. A portion of the normally liquid phase is recycled to the first reaction zone as the cyclohexane concentrate hereinbefore described. The remainder of the normally liquid phase is passed into a stabilizing column functioning at an operating pressure of about 250 psig, a top temperature of about 160° F. and a bottom temperature of about 430° F. The cyclohexane product is withdrawn drawn from the stabilizer as a bottoms stream, the overhead stream being vented to fuel. The cyclohexane concentrate is recovered in an amount of about 245.80 moles per hour, of which only about 0.60 moles per hour constitutes other hexanes. In brief summation then, from the 19,207 pounds per hour of fresh benzene feed, 20,685 per hour of cyclohexane product is recovered.

### Example 3

Another hydrocarbon hydroprocessing scheme, to which the present invention is applicable, involves the hydrorefining of coke-forming hydrocarbon distillates. The hydrocarbon distillates generally contain mono-olefinic, di-olefinic and aromatic hydrocarbons. Through the utilization of a catalytic composite comprising a noble metal component, increased selectivity and stability of operation is obtained; selectivity is most noticeable with respect to the retention of aromatics, and in hydrogenating conjugated diolefinic and mono-olefinic hydrocarbons. Such charge stocks generally result from diverse conversion processes including the catalytic and/or thermal cracking of petroleum, sometimes referred to as pyrolysis, the destructive distillation of wood or coal, shale oil retorting, etc. The impurities in these distillate fractions must necessarily be removed before the distillates are suitable for their intended use, or which when removed, enhance the value of the distillate fraction for further processing. Frequently, it is intended that these charge stocks be saturated to the extent necessary to remove the conjugated di-olefins, while simultaneously retaining the aromatic hydrocarbons. When subjected to hydrorefining for the purpose of removing the contaminating influences, there is encountered difficulty in effecting the desired degree of reaction due to the formation of coke and other carbonaceous material.

As utilized herein, “hydrogenating” is intended to be synonymous with “hydrorefining.” The purpose is to provide a highly selective and stable process for hydrogenating coke-forming hydrocarbon distillates, and this is accomplished through the use of a fixed-bed catalytic reaction system utilizing a metal catalyst component. There exists two separate, desirable routes for the treatment of coke-forming distillates, for example a pyrolysis naphtha by-product. One such route is directed toward a product suitable for use in certain gasoline blending. With this as the desired object, the process can be effected in a single stage, or reaction zone, with the catalytic composite hereinafter specifically described as the first-stage catalyst. The attainable selectivity in this instance resides primarily in the hydrogenation of highly reactive double bonds. In the case of conjugated di-olefins, the selectivity afforded restricts the hydrogenation to produce mono-olefins, and, with respect to the styrenes, for example, the hydrogenation is inhibited to produce alkyl benzenes without “ring” saturation. The selectivity is accomplished with a minimum of polymer formation either to “gums,” or lower molecular weight polymers which would necessitate a re-running of the product before blending to gasoline would be feasible. It must be noted that the mono-olefins, whether virgin, or products of di-olefin partial saturation, are unchanged in the single, or first-stage reaction zone. Where however the desired end result is aromatic hydrocarbon retention, intended for subsequent extraction, the two-stage route is required. The mono-olefins must be substantially saturated in the second stage to facilitate aromatic extraction by way of currently utilized methods. Thus, the desired necessary hydrogenation involves saturation of the mono-olefins. Attendant upon this is the necessity to avoid even partial saturation of aromatic nuclei.

With respect to one catalytic composite, its principal function involves the selective hydrogenation of conjugated diolefinic hydrocarbons to mono-olefinic hydrocarbons. The catalytic composite comprises an alumina-containing refractory inorganic oxide, a noble metal component, such as platinum, and an alkali-metal component, the latter being preferably potassium and/or lithium. Through the utilization of a particular sequence of processing steps, and the use of the foregoing described catalyst composites, the formation of high molecular weight polymers is inhibited to a degree which permits processing for an extended period of time. Briefly, this is accomplished by initiating the hydrorefining reactions at temperatures below about 500° F., at which temperatures the coke-forming reactions are not promoted.

The hydrocarbon distillate charge stock, for example a light naphtha by-product from a commercial cracking unit designed and operated for the production of ethylene, having a gravity of about 34.0° API, a bromine number of about 35.0, a diene value of about 17.5 and containing 75.9 vol. % aromatic hydrocarbons, is admixed with recycled hydrogen. This light naphtha co-product has an initial boiling point of about 164° F. and an end boiling point of about 333° F. The hydrogen circulation rate is within the range of from about 1,000 to about 10,000 scf/Bbl, and preferably in the narrower range of from 1,500 to about 6,000 scf/Bbl. The charge stock is heated to a temperature such that the maximum catalyst temperature is in the range of from about 200° F. to about 500° F., by way of heat-exchange with various product effluent streams, and is introduced into the first reaction zone at an LHSV in the range of about 0.5 to about 10.0. The reaction zone is maintained at a pressure of from 400 to about 1,000 psig, and preferably at a level in the range of from 500 to about 900 psig.

The temperature of the product effluent from the first reaction zone is increased to a level above about 500° F., and preferably to result in a maximum catalyst temperature in the range of 600 to 900° F. The saturation of mono-olefins, contained within the first zone effluent, is effected in the second zone. When the process is functioning efficiently, the diene value of the liquid charge entering the second catalyst reaction zone is less than about 10.0 and often less than about 0.3. The second catalytic reaction zone is maintained under an imposed pressure of from about 400 to about 1,000 psig, and preferably at a level of from about 500 to about 900 psig. The two-stage process is facilitated when the focal point for pressure control is the high pressure separator serving to separate the product effluent from the second catalytic reaction zone. It will, therefore, be maintained at a pressure slightly less than the first catalytic reaction zone, as a result of fluid flow through the system. The LHSV through the second reaction zone is about 0.5 to about 10.0, based upon fresh feed only. The hydrogen circulation rate will be in a range of from 1,000 to about 10,000 scf./Bbl., and preferably from about 1,000 to about 8,000 scf./Bbl. Series-flow through the entire system is facilitated when the recycle hydrogen is admixed with the fresh hydrocarbon charge stock. Make-up hydrogen, to supplant that consumed in the overall process, may be introduced from any suitable external source, but is preferably introduced into the system by way of the effluent line from the first catalytic reaction zone to the second catalytic reaction zone.

With respect to the naptha boiling range portion of the product effluent, the aromatic concentration is about 75.1% by volume, the bromine number is less than about 0.3 and the diene value is essentially “nil”.

With charge stocks having exceedingly high diene values, a recycle diluent is employed in order to prevent an excessive temperature rise in the reaction system. Where so utilized, the source of the diluent is preferably a portion of the normally liquid product effluent from the second catalytic reaction zone. The precise quantity of recycle material varies from feed stock to feed stock; however, the rate at any given time is controlled by monitoring the diene value of the combined liquid feed to the first reaction zone. As the diene value exceeds a level of about 25.0, the quantity of recycle is increased, thereby increasing the combined liquid feed ratio; when the diene value approaches a level of about 20.0, or less, the quantity of recycle diluent may be lessened, thereby decreasing the combined liquid feed ratio.

### Example 4

This illustration of a hydrocarbon hydroprocessing scheme, encompassed by our invention is one which involves hydrocracking heavy hydrocarbonaceous material into lower-boiling hydrocarbon products. In this instance, the preferred catalysts contain a germanium component, a platinum group metal component, a cobalt component, and a halogen component combined with a crystalline aluminosilicate-carrier material, such as faujasite, and one which is at least 90.0% by weight zeolitic.

Most of the virgin stocks, intended for hydrocracking, are contaminated by sulfurous compounds and nitrogenous compounds, and, in the case of the heavier charge stocks, various metallic contaminants, insoluble asphalts, etc. Contaminated charge stocks are generally hydrorefined in order to prepare a charge suitable for hydrocracking. Thus, the catalytic process of the present invention can be beneficially utilized as the second stage of a two-stage process, in the first stage of which the fresh feed is hydrorefined.

Hydrocracking reactions are generally effected at elevated pressures in the range of about 800 to 5,000 psig, and preferably at some intermediate level of 1,000 to about 3,500 psig. Liquid hourly space velocities of about 0.25 to about 10.0 will be suitable, the lower range generally reserved for the heavier stocks. The hydrogen circulation rate will be at least about 3,000 scf/Bbl, with an upper limit of about 50,000 scf/Bbl, based upon fresh feed. For the majority of feed stocks, hydrogen circulation in the range of 5,000 to 20,000 scf./Bbl. will suffice. With respect to the LHSV, it is based upon fresh feed, notwithstanding the use of recycle liquid providing a combined liquid feed ratio in the range of about 1.25 to about 6.0. The operating temperature again alludes to the temperature of the catalyst within the reaction zone, and is in the range of about 400° to about 900° F. Since the principal reactions are exothermic in nature, the increasing temperature gradient, experienced as the charge stock traverses the catalyst bed, results in an outlet temperature higher than that at the inlet to the catalyst bed. The maximum catalyst temperature should not exceed 900° F., and it is generally a preferred technique to limit the temperature increase to 100° F. or less.

Although amorphous composites of alumina and silica, containing from about 10.0 to about 90.0% by weight of the latter, are suitable for use in the catalytic composite employed in the present process, a preferred carrier material constitutes a crystalline aluminosilicate, preferably faujasite, of which at least about 90.0% by weight is zeolitic. This carrier material, and a method of preparing the same, have hereinbefore been described.

A specific illustration of this hydrocarbon hydroprocessing technique involves the use of a catalytic composite of about 0.4 to about 2.8% by weight of platinum, 0.7% by weight of combined chlorine, combined with a crystalline aluminosilicate material of which about 90.0% by weight constitutes faujasite. This catalyst is intended for utilization in the conversion of 16,000 Bbl/day of a blend of light gas oils to produce maximum quantities of a heptane-400° F. gasoline boiling range fraction. The charge stock has a gravity of 33.8° API, and has an initial boiling point of 369° F., a 50% volumetric distillation temperature of 494° F. and an end boiling point of 655° F. The charge stock is initially subjected to a clean-up operation at maximum catalyst temperature of 750° F., an LHSV of 1.0 with a hydrogen circulation rate of about 5000 scf/Bbl The pressure imposed upon the catalyst within the reaction zone is about 1,500 psig. Since at least a portion of the blended gas oil charge stock will be converted into lower-boiling hydrocarbon products, the effluent from this clean-up reaction zone is separated to provide a normally liquid, 400° F.-plus charge for the hydrocracking reaction zone containing the hereinabove described catalyst. The pressure imposed upon the second reaction zone is about 1,500 psig, and the hydrogen circulation rate is about 8,000 scf/Bbl The original quantity of fresh feed to the clean-up reaction zone is about 16,000 Bbl/day; following separation of the first zone effluent to provide the 400° F.-plus charge to the second reaction zone, the charge to the second reaction zone is in an amount of about 12,150 Bbl/day, providing an LHSV of 0.85. The temperature at the inlet to the catalyst bed is 665° F., and a conventional hydrogen quench stream is utilized to maintain the maximum reactor outlet temperature at about 700° F. Following separation of the product effluent from the second reaction zone, to concentrate the desired gasoline boiling range fraction, the remaining 400° F.-plus normally liquid material, in an amount of 7,290 Bbl/day, is recycled to the inlet of the second reaction zone, thus providing a combined liquid feed ratio thereto of about 1.60.

An analysis of the components in stage 1 and stage 2 is carried out to assess the yields of ammonia, hydrogen sulfide, methane, ethane, propane, butanes, pentanes, hexanes, C7-400° F. and 400° F.-plus products. An analysis of the gravity values of the combined pentane/hexane fraction is carried out. A gravity of 85.0 corresponds to a clear research octane rating and gravity of 99.0 corresponds to a leaded research octane rating for pentane/hexane. A sample in this range constitutes an excellent blending component for motor fuel. The gravity of a desired heptane-400° F. product for a clear research octane rating is 72.0 and a leaded research octane rating is 88.0.

While the disclosure includes a limited number of embodiments, those skilled in the art, having the benefit of this disclosure, will appreciate that other embodiments may be devised which do not depart from the scope of the present disclosure.

What is claimed is:

1. A process for selective ring-opening of aromatic and cycloparaffinic rings comprising: contacting hydrocarbon species comprising aromatic and cycloparaffinic rings with hydrogen in the presence of a ring-opening catalyst comprising a noble metal on a low-acidity crystalline material comprising external pockets to facilitate ring-opening of the hydrocarbon species comprising aromatic and cycloparaffinic rings.

2. The process of claim 1, wherein the external pockets of the low-acidity crystalline material are formed by the delamination of zeolites.

3. The process of claim 1, wherein the low-acidity crystalline material is formed from the delamination of one or more types of zeolite selected from a borosilicate or aluminoborosilicate molecular sieve containing at least 0.05 weight percent boron and less than 1000 ppm by weight of aluminum, or a titanosilicate molecular sieve; aluminosilicate; and silico-aluminium phosphates and mixtures thereof.

4. The process of claim 1, wherein the low-acidity crystalline material is formed from the delamination of one or more types of zeolite selected from SSZ-33, SSZ-46, SSZ-53, SSZ-55, SSZ-57, SSZ-58, SSZ-59, SSZ-60, SSZ-64, SSZ-70, ZSM-5, ZSM-11, TS-1, MTT (e.g., SSZ-32, ZSM-23 and the like), H—Y and combinations thereof.

5. The process of claim 1, wherein the low-acidity crystalline material is formed from the delamination of one or more types of aluminosilicate zeolite.

6. The process of claim 1, wherein the noble metal is selected from the group consisting of platinum, palladium, nickel, rhodium, iridium, ruthernium, osmium and mixtures thereof.

7. The process of claim 1, wherein the process is carried out at a temperature of about 200° C. to about 400° C., a pressure in the range of about 200 psig to about 2000 psig, and weight hourly space velocity in the range of about 0.4 to about 0.7 WHSV hr⁻¹.

8. A process for converting polynuclear aromatic hydrocarbons (PAHs) to ring-opened products comprising: (i) hydrogenation of PAHs by a hydrogenation catalyst and hydrogen to produce hydrocarbon species comprising aromatic and cycloparaffinic rings; and (ii) contacting the hydrocarbon species comprising aromatic and cycloparaffinic rings with hydrogen in the presence of a ring-opening catalyst comprising a noble metal on a low-acidity crystalline material comprising external pockets to facilitate ring-opening of the hydrocarbon species comprising aromatic and cycloparaffinic rings.

9. The process of claim 8, wherein the PAHs comprise C₁₀ to C₃₂ PAHs.

10. The process of claim 8, wherein the PAHs are from a hydrocracker recycle stream.

11. The process of claim 8, wherein the external pockets of the low-acidity crystalline material are formed by the delamination of zeolites.

12. The process of claim 8, wherein the low-acidity crystalline material is formed from the delamination of one or more types of zeolite selected from a borosilicate or aluminoborosilicate molecular sieve containing at least 0.05 weight percent boron and less than 1000 ppm by weight of aluminum, or a titanosilicate molecular sieve; aluminosilicate; and silico-aluminium phosphates and mixtures thereof.

13. The process of claim 8, wherein the low-acidity crystalline material is formed from the delamination of one or more types of zeolite selected from SSZ-33, SSZ-46, SSZ-53, SSZ-55, SSZ-57, SSZ-58, SSZ-59, SSZ-60, SSZ-64, SSZ-70, ZSM-5, ZSM-11, TS-1, MTT (e.g., SSZ-32, ZSM-23 and the like), H—Y and combinations thereof.

14. The process of claim 8, wherein the low-acidity crystalline material is formed from the delamination of one or more types of aluminosilicate zeolite.

15. The process of claim 8, wherein the noble metal is selected from the group consisting of platinum, palladium, nickel, rhodium, iridium, ruthernium, osmium and mixtures thereof.

16. The process of claim 8, wherein the process is carried out at a temperature of about 200° C. to about 400° C., a pressure in the range of about 200 psig to about 2000 psig, and weight hourly space velocity in the range of about 0.4 to about 0.7 WHSV hr⁻¹.

17. A composition comprising a ring-opened hydrocarbon species produced from hydrocarbon species comprising aromatic and cycloparaffinic rings treated in accordance with the process of claim 1.

18. A composition comprising a ring-opened hydrocarbon species produced from hydrocarbon species comprising aromatic and cycloparaffinic rings treated in accordance with the process of claim 8.
